(19) United States
(12) Patent Application Publication
(10) Pub. No.: US 2009/0213710 A1
(43) Pub. Date: Aug. 27, 2009

(54) REPRODUCING INFORMATION FROM ANINFORMATION CARRIER

(75) Inventors: Bart Van Rompaey, Eindhoven (NL); Maarten Kuijper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,311

(22) PCT Filed: Nov. 16, 2005
(86) PCT No.: PCT/IB2005/053785

§ 371 Date: Mar. 17, 2009

(30) Foreign Application Priority Data
Nov. 18, 2004 (EP) 04105882.7

(51) Int. Cl. G11B 15/52; G11B 7/135

(52) U.S. Cl. 369/47.25; 369/112.01; G9B/7

(57) ABSTRACT

The invention described is an apparatus for reproducing information from an information carrier (11) comprising: a waveform equalizer (6) for obtaining a corrected signal (S′) by performing a waveform equalization to a read signal (S), the waveform equalizer (6) having an amplifying element with a gain (K); and gain setting means (1) for reading a numerical gain setting stored on the information carrier (11) and setting the gain (K) of the amplifying element to a value related to the numerical gain setting. By reading the numerical gain setting from the information carrier, the apparatus is able to set the gain (K) of the waveform equalizer to the optimal value for suppressing noise and inter symbol interference. The equalizer can be followed by a limit equalizer, the gain of which can also be wave form read from the information carrier.

The present invention relates to an apparatus for reproducing information recorded on an information carrier.

The invention further relates to an information carrier for use in such an apparatus.

The invention also relates to a method for reproducing information recorded on an information carrier.

An apparatus for reproducing information from an information carrier having a waveform equalizer is known from European Patent application 0940811 A1. In the known apparatus an optical pickup unit reads recorded information from a recording disk. The recording disk is rotated by a spindle motor. The optical pickup unit supplies a read signal to an amplifier. The amplifier amplifies the read signal to a desired level and supplies an obtained read signal to a waveform equalizer. An amplitude limiting circuit present in the waveform equalizer converts a signal level of the read signal by limiting the amplitude of the read signal. The amplitude limited read signal is supplied to a high-frequency emphasizing filter. The high-frequency emphasizing filter emphasizes the level of high frequency components of the amplitude limited read signal and supplies a resultant signal as an equalization correction read signal to a binary value decision circuit. The binary value decision circuit discriminates whether the signal level of the equalization correction read signal corresponds to either one of the logical levels “1” and “0”, and generates a result of the discrimination as reproduction data.

The density of the information on the information carriers becomes higher and higher as the area of information recording is more developed. From DVD to Blu-ray Disc egalization of the read signal has therefore become more and more a necessity in order to reduce inter symbol interference. Egalization makes it possible to detect the smallest signals in the read signal properly. In the case of Blu-ray Disc the smallest signals are called the 12's. They represent the highest frequencies of the channel and have the smallest amplitude due to the optical MTF which has its cut off near to that high frequency. The so called limit equalizer described in EP-A-0940811 is better in reducing Inter Symbol interference and therefore performs very well to make the ‘eye’ in the read signal open (unequalized read signals may have closed ‘eyes’ because of the very small I2 signals). An important parameter of an equalizer is its gain; a measure of the ‘boost’ the equalizer gives.

When reading out the information carrier more or less noise is contained in the read signal. The characteristics of the noise are dependent on the type of information carrier. For instance, for Blu-ray Disc Rewritable there are defined three different capacities in the physical specification: 23.3 GB, 25 GB and 27 GB. Each of these three capacities have a different channel bit length which decreases for increasing capacities. The smaller the channel bit length, the more difficult the 12 signals become to detect. This is related to the noise in the read signal. The gain setting of the equalizer such that, given the noise characteristic, the 12's are optimally boosted is therefore dependent on the type of information carrier. For write once recording, such as Blu-ray disc Recordable, there are different media types which are suited. These media types are organic (dye) and inorganic types and Low to High (L2H) media. The different media types have mutually different noise characteristics or obtain less modulation at the highest frequencies as one can expect from the MTF and therefore need different optimal gain settings for the equalizer.

Thus, the optimal gain setting for the equalizer is dependent on the type of information carrier. For optimal reading the information carrier the apparatus for reproducing information on the information carrier needs to know the optimal gain setting for the equalizer. The known apparatus can not determine the optimal gain setting and does therefore reproduce information with a gain setting which may not be optimal. The noise and inter symbol interference in the read signal is consequently not suppressed optimally by the equalizer.

It is an object of the invention to provide an apparatus for reproducing information as described in the opening paragraph, which better suppresses the noise and inter symbol interference in the read signal.

It is a further object of the invention to provide a method for reproducing information as described in the opening paragraph, which better suppresses the noise and inter symbol interference in the read signal.

It is still a further object of the invention to provide an information carrier for use in the apparatus according to the invention.

Therefore, the apparatus according to the invention comprises:

a waveform equalizer for obtaining a corrected signal S′ by performing a waveform equalization to a read signal S read out from the information carrier, the waveform equalizer having an amplifying element with a gain K;

gain setting means for reading a numerical gain setting stored on the information carrier setting the gain K of the amplifying element to a value related to the numerical gain setting.

The method according to the invention comprises the steps of:

obtaining a corrected signal S′ by performing a waveform equalization to a read signal S read out from the information carrier using a waveform equalizer having an amplifying element with a gain K;

reading a numerical gain setting stored on the information carrier and setting the gain K of the amplifying element to a value related to the numerical gain setting.

On the information carrier in accordance with the invention the numerical gain setting is stored.

The optimal gain setting of the equalizer for a given information carrier can be determined in advance by analyzing the information carrier. By storing the determined optimal gain setting in the form of the numerical gain setting on the information carrier, the apparatus in accordance with the invention is able to read the optimal gain and setting the gain K of the amplifying element accordingly. The equalizer can subsequently perform optimally for that information carrier by optimally suppressing the noise and inter symbol interference in the read signal.

In an embodiment of the apparatus according to the invention the waveform equalizer comprises a FIR filter able to perform a filtering process to said read signal S, the FIR filter having tap coefficients

$$[ \frac{- K}{2} , \frac{1 + K}{2} , \frac{1 + K}{2} , \frac{- K}{2} ] .$$

The abbreviation FIR stands for Finite Impulse Response. This filter thus has an impulse response which is finite. Such a filter consists of tap delays, amplifying units and an adder for adding the outputs of the tap delays and amplifying units. The amplifying units have an amplification of K, Depending on the value of K, the waveform equalizer has a certain frequency response. The gain K is set by reading the optimal gain from the information carrier and setting the gain K accordingly. This waveform equalizer can be used in run length limited, RLL, codes. RLL codes are indicated by parameters d and k. The d stands for a minimum run length constraint, and the k for a maximum run length constraint. A run length smaller than d+1 is not allowed, a run longer than k+1 is not allowed either. The described waveform equalizer is suitable for a RLL code where d=1.

This FIR filter is a 4-tap transversal filter with transfer function:

$$H ( z ) = - \frac{K}{2} + \frac{1 + K}{2} ⋆ {z}^{- 1} + \frac{1 + K}{2} ⋆ {z}^{- 2} - \frac{K}{2} ⋆ {z}^{- 3}$$

In an apparatus such as a Blu-Ray Disc writer the waveform equalizer can be followed by a limit equalizer.

A limit equalizer is described in EP-A-0940811. As is described in EP-A-0940811 the limit equalizer suppresses noise and inter symbol interference substantially.

In a further embodiment of the apparatus according to the invention the limit equalizer comprises:

a first FIR filter able to perform a filtering process to said read signal S, having tap coefficients [0,0,0,1];

amplitude limiting means able to obtain an amplitude limited read signal by limiting an amplitude level of said read signal S by a predetermined amplitude limitation value;

a second FIR filter able to perform a filtering process to said amplitude limited read signal, having tap coefficients [−m,m,m,−m], m being a suitable amplification factor;

an adder able to add the signals obtained by performing the filtering process by each of said first and second filters, and output the corrected signal S′. In case of the Blu-Ray Disc writer a suitable value of the amplification factor m would be m= 3/16. In an embodiment of the apparatus according to the invention the gain setting means 1 are adapted to read an additional numerical gain setting and to set an amplification factor of the limit equalizer a value related to the additional numerical gain setting.

An example of an information carrier is an DVD+R optical disc. The area of the disc on which information is or can be written is called the information zone. The information zone consists of an Inner Drive Area, a Lead-in Zone, a Data Zone, Lead-out Zone and an Outer Drive Area. The Lead-in Zone contains control information. The Lead-in Zone is located at the inner side of the Information Zone. The Lead-in Zone comprises a Control Data Zone. The Control Data Zone contains physical format information, disc manufacturing information and content provider information. The physical format information contains information such as disc size, recording density, maximum read power, parameter settings for recording etc. . . . . The numerical gain setting can be stored in the physical format information table.

These and other aspects of the apparatus, information carrier and method according to the invention will be apparent from and elucidated by means of the drawings, in which:

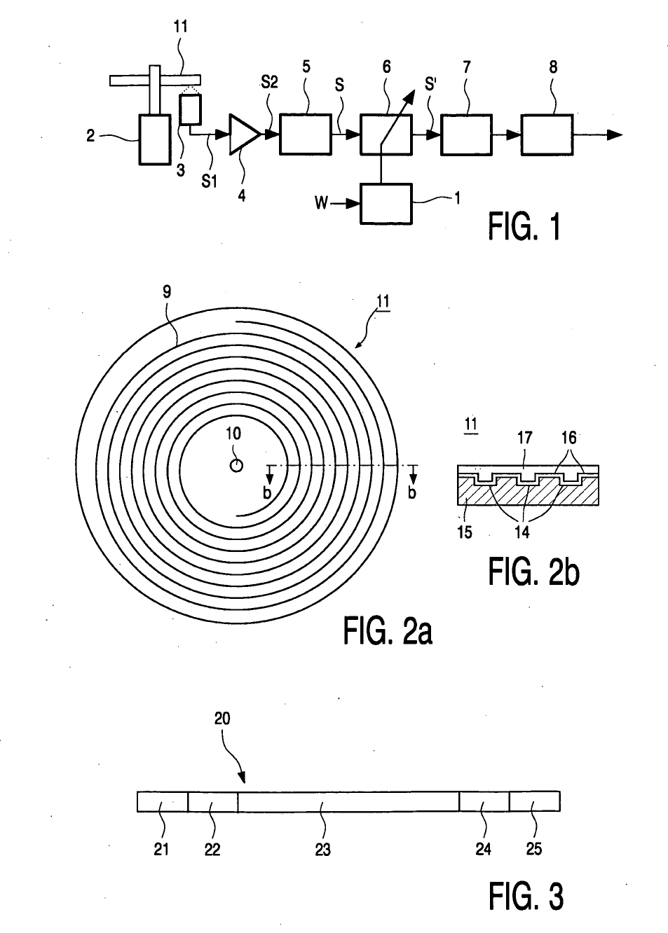

FIG. 1 shows an apparatus for reproducing information according to the invention,

FIG. 2a shows an information carrier (top view),

FIG. 2b shows an information carrier (cross section),

FIG. 3 shows an example of the information zone of an information carrier,

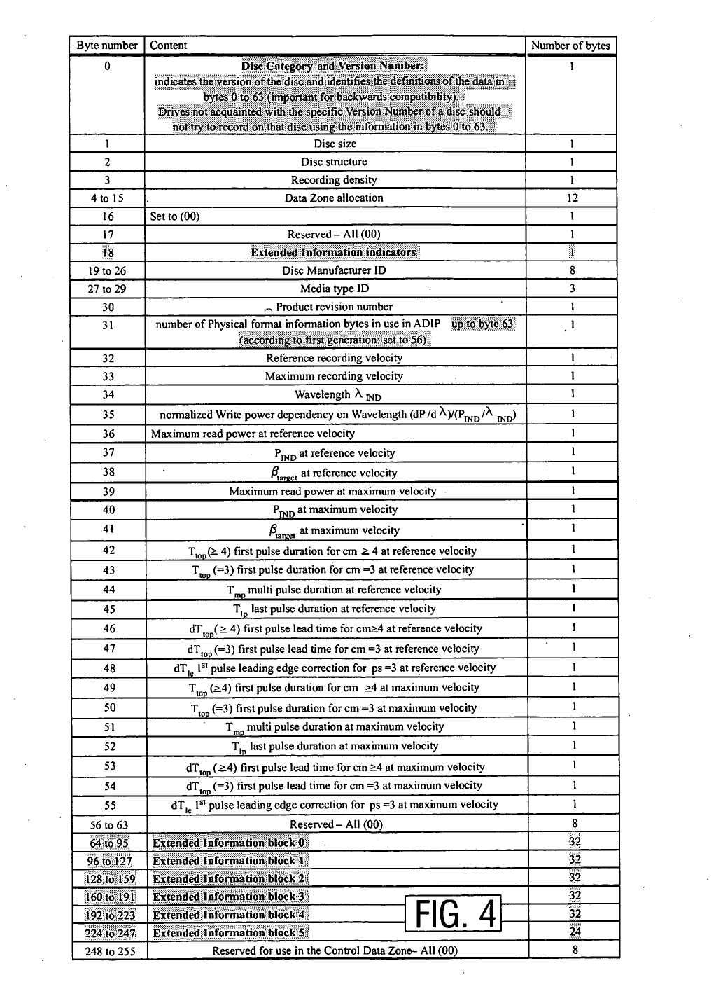

FIG. 4 shows a table of an example of physical format information,

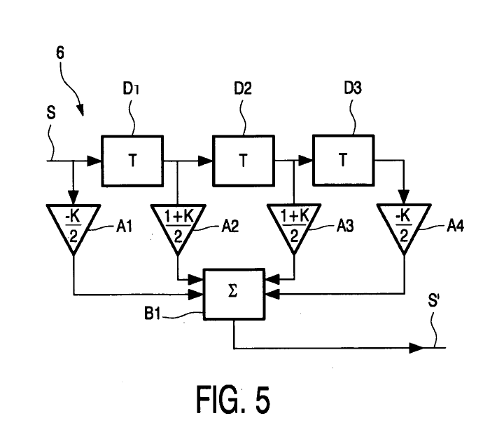

FIG. 5 shows and example of a waveform equalizer, and

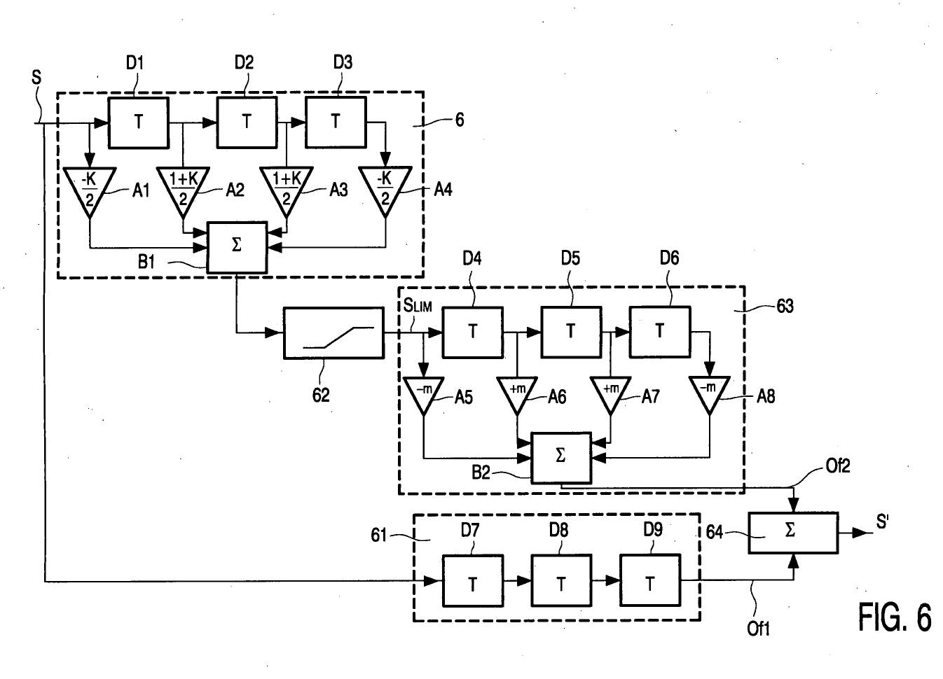

FIG. 6 shows a waveform equalizer followed by a limit equalizer.

The apparatus for reproducing information shown in FIG. 1 comprises a read head 3 for reading the information from an information carrier 11. A displacement means 2 is able to cause a relative displacement between the information carrier 11 and the read head 3. In operation, an output signal S₁ of the read head 3 is fed to an amplifier 4. The amplifier 4 amplifies the output signal S₁ to a desired level and supplies an amplified signal S2 to an analog to digital A/D converter 5. The A/D converter 5 converts the amplified signal S2 to a sampled read signal S, using a sampling period of T seconds. The sampled read signal S is fed to the waveform equalizer 6. The waveform equalizer 6 obtains a corrected signal S′ by performing a waveform equalization to the read signal S. The output of the waveform equalizer 6 is fed to bit-detection means 7. The output of the bit-detection means 7 is fed to channel decoding means 8. The gain setting means 1 are able to read the numerical gain from the information carrier and setting the gain K of the waveform equalizer to a value related to the stored numerical gain setting. In FIG. 1 the numerical gain is read out via the wobble channel W, however the invention is not limited to reading out the numerical gain via the wobble channel W. In an other embodiment the numerical gain can be read out via the read signal channel. Straightforwardly the gain K will be set to a value equal to the stored numerical gain setting.

FIG. 2a shows a disc-shaped information carrier 11 having a track 9 and a central hole 10. The track 9, being the position of the series of (to be) recorded marks representing information, is arranged in accordance with a spiral pattern of turns constituting substantially parallel tracks on an information layer. The information carrier may be optically readable, called an optical disc, and has an information layer of a recordable type. Examples of a recordable disc are the CD-R and CD-RW, and writable versions of DVD, such as DVD+RW. Further details about the DVD disc can be found in reference: ECMA-267: 120 mm DVD—Read-Only Disc—(1997). The information is represented on the information layer by recording optically detectable marks along the track, e.g. crystalline or amorphous marks in phase change material. The track 9 on the recordable type of information carrier is indicated by a pre-embossed track structure provided during manufacture of the blank information carrier. The track structure is constituted, for example, by a pregroove 14 which enables a read/write head to follow the track during scanning. The track structure comprises position information, e.g. addresses, for indication the location of units of information, usually called information blocks. The position information includes specific synchronizing marks for locating the start of such information blocks. The position information is encoded in frames of modulated wobbles as described below.

FIG. 2b shows a part of a cross-section taken along the line b-b of the information carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The information carrier 11 is intended for carrying information represented by modulated signals comprising frames. A frame is a predefined amount of data preceded by a synchronizing signal. Usually such flames also comprise error correction codes, e.g. parity words. A number of such frames constitute an information block, the information block comprising further error correction words. The information block is the smallest recordable unit from which information can be reliably retrieved. An example of such a recording system is known from the DVD system, in which the frames carry 172 data words and 10 parity words, and 208 frames constitute an ECC block.

FIG. 3 shows an example of the information zone 20 of an information carrier 11. The information zone 20 contains all the information on the information carrier relevant for data interchange. The Inner Drive Area 21 and Outer Drive Area 25 are meant for disc testing. The Lead-in Zone 22 contains control information. The Lead-out Zone 24 allows for a smooth lead-out and also contains control information. The Data zones 23 are intended for recording of user data. The Lead-in Zone contains a Control Data Zone.

FIG. 4 shows a table of an example of physical format information contained in the Control Data Zone. The Physical format information is encoded in ADIP as described above. This information shall comprise the 256 bytes shown in FIG. 4. It contains disc information and values used for the Optimum Power Control (OPC) algorithm to determine optimum laser power levels for writing. The information is copied into a recordable zone called the Control Data during initialization of the disc. The data contents are for example:

### Byte 0—Disc Category and Version Number

Bits b7 to b4 shall specify the Disc Category,
   they shall be set to 1010, indicating a DVD+R disc.
Bits b3 to b0 shall specify the Version Number,
   they shall be set to 0000 indicating the version
      Byte 1—Disc size and maximum transfer rate
Bits b7 to b4 shall specify the disc size,
   they shall be set to 0000, indicating a 120 mm disc
Bits b3 to b0 shall specify the maximum read transfer rate,
   they shall be set to 1111 indicating no maximum read transfer rate is specified
      Byte 2—Disc structure
Bit b7 to b4 shall be set to 0000
Bits b3 to b0 shall specify the type of the recording layer(s):
   they shall be set to 0010, indicating a write-once recording layer.
      Byte 3—Recording density
Bits b7 to b4 shall specify the average Channel bit length in the Information Zone,
   they shall be set to 0000, indicating 0.133 μm
Bits b3 to b0 shall specify the average track pitch,
   they shall be set to 0000, indicating an average track pitch of 0.74 μm
      Bytes 4 to 15—Data Zone allocation
Byte 4 shall be set to (00).
Bytes 5 to 7 shall be set to (030000) to specify PSN 196.608 of the first Physical Sector of the Data Zone
Byte 8 shall be set to (00).
Bytes 9 to 11 shall be set to (26053F) to specify PSN 2.491.711 as the last possible Physical Sector of the Data Zone.
Bytes 12 to 15 shall be set to (00)
   Byte 16—(00) shall be set to (00).
   Byte 17—Reserved. This byte is reserved and shall be set to (00).
   Byte 18—Extended information indicators
Bits b7 to b6 are reserved and shall be set to 00
Bits b5 to b0 each of these bits shall indicate the presence of an Extended Information block. Bit bᵢ shall be set to 1 if Extended Information block i, consisting of bytes (64+i×32) to (95+i×32), is in use. Else bit bᵢ shall be set to 0.

### Bytes 19 to 26—Disc Manufacturer ID.

These 8 bytes shall identify the manufacturer of the disc. Trailing bytes not used shall be set to (00).
   Bytes 27 to 29—Media type ID.
Disc manufacturers can have different types of media, which shall be specified by these 3 bytes. The specific type of disc is denoted in this field.
   Byte 30—Product revision number.
This byte shall identify the product revision number in binary notation. All discs with the same Disc Manufacturer ID and the same Product ID, regardless of Product revision numbers, must have the same recording properties (only minor differences are allowed: Product revision numbers shall be irrelevant for recorders). If not used this byte shall be set to (00)
   Byte 31—number of Physical format information bytes in use.
This byte forms one 8-bit binary number indicating the number of bytes actually in use for Physical format information. It shall be set to (36) indicating that only the first 54 bytes of the Physical format information are used.
   Byte 32—Reference recording velocity.
This byte indicates the lowest possible recording velocity of the disc, which is also referred to as the Reference velocity, as a number n such that

n=10×v_{ref} (n rounded off to an integral value)
It shall be set to (23) indicating a Reference writing speed of 3.49 m/s.
   Byte 33—Maximum recording velocity.
This byte indicates the highest possible recording velocity of the disc, as a number n such that

n=10×v_{ref} (n rounded off to an integral value)
It shall be set to (54) indicating a maximum writing speed of 8.44 m/s.

### Byte 34—Wavelength λIND.

This byte shall specify the wavelength in nanometers of the laser with which the optimum write parameters in the following bytes have been determined, as a number n such that

n=Wavelength−600

### Byte 35—Reserved

Byte 36—Maximum read power, Pr at reference velocity.
This byte shall specify the maximum read power Pr in milliwatts at the reference velocity as a number n such that

n=20×(Pr−0.7)

Byte 37—PIND at reference velocity.
PIND is the starting value for the determination of Ppo used in the OPC algorithm. This byte shall specify the indicative value PIND of Ppo in milliwatts at the reference velocity as a number n such that

n=20×(P_{IND}−5)

Byte 38—β_{target} at reference velocity.
This byte shall specify the target value for β, β_{target} at the reference velocity used in the OPC algorithm as a number n such that

n=10×β_{target}

Byte 39—Maximum read power, Pr at maximum velocity.
This byte shall specify the maximum read power Pr in milliwatts at the maximum velocity as a number n such that

n=20×(Pr−0.7)

Byte 40—P_{IND} at maximum velocity.
P_{IND} is the starting value for the determination of Ppo used in the OPC algorithm. This byte shall specify the indicative value PIND of Ppo in milliwatts at the maximum velocity as a number n such that

n=20×(PIND−5)

Byte 41—β_{target} at maximum velocity.
This byte shall specify the target value for β, β_{target} the maximum velocity used in the OPC algorithm as a number n such that

n=10×β_{target}

Byte 42—Ttop (≧4) first pulse duration for current mark ≧4 at reference velocity.
This byte shall specify the duration of the first pulse of the multi pulse train when the current mark is a 4T or greater mark for recording at reference velocity. The value is expressed in fractions of the channel bit clock period as a number n such that

n=16×Tₜₒₚ/T_{W} and 4≦n≦40

Byte 43—Ttop (=3) first pulse duration for current mark =3 at reference velocity.
This byte shall specify the duration of the first pulse of the multi pulse train when the current mark is a 3T mark for recording at reference velocity. The value is expressed in fractions of the channel bit clock period as a number n such that

n=16×Tₜₒₚ/T_{W} and 4≦n≦40

Byte 44—Tmp multi pulse duration at reference velocity.
This byte shall specify the duration of the 2nd pulse through the 2nd to last pulse of the multi pulse train for recording at reference velocity. The value is expressed in fractions of the channel bit clock period as a number n such that

n=16×Tₘₚ/T_{W} and 4≦n≦16

Byte 45—Tlp last pulse duration at reference velocity.
This byte shall specify the duration of the last pulse of the multi pulse train for recording at reference velocity. The value is expressed in fractions of the channel bit clock period as a number n such that

n=16×Tₗₚ/T_{W} and 4≦n≦24

Byte 46—dTtop first pulse lead time at reference velocity.
This byte shall specify the lead time of the first pulse of the multi pulse train relative to the trailing edge of the second channel bit of the data pulse for recording at reference velocity. The value is expressed in fractions of the channel bit clock period as a number n such that

n=16×dTₜₒₚ/T_{W} and 0≦n≦24

Byte 47—dTle 1st pulse leading edge correction for previous space =3 at reference velocity.
Bit 7 to bit 4 of this byte shall specify the leading edge correction for the 1st pulse of the multi pulse train when the previous space was a 3T space for recording at reference velocity. The value is expressed in fractions of the channel bit clock period according to FIG. 8.
   Byte 48—Ttop (≧4) first pulse duration for current mark ≧4 at maximum velocity.
This byte shall specify the duration of the first pulse of the multi pulse train when the current mark is a 4T or greater mark for recording at maximum velocity. The value is expressed in fractions of the channel bit clock period as a number n such that

n=16×Tₜₒₚ/T_{W} and 4≦n≦40

Byte 49—Ttop (3) first pulse duration for current mark=3 at maximum velocity.
This byte shall specify the duration of the first pulse of the multi pulse train when the current mark is a 3T mark for recording at maximum velocity. The value is expressed in fractions of the channel bit clock period as a number n such that

n=16×Tₜₒₚ/T_{W} and 4≦n≦40

Byte 50—Tmp multi pulse duration at maximum velocity.
This byte shall specify the duration of the 2nd pulse through the 2nd to last pulse of the multi pulse train for recording at maximum velocity. The value is expressed in fractions of the channel bit clock period as a number n such that

n=16×Tₘₚ/T_{W} and 4≦n≦16

Byte 51—Tlp last pulse duration at maximum velocity.
This byte shall specify the duration of the last pulse of the multi pulse train for recording at maximum velocity. The value is expressed in fractions of the channel bit clock period as a number n such that

n=16×Tₗₚ/T_{W} and 4≦n≦24

Byte 52—dTtop first pulse lead time at maximum velocity.
This byte shall specify the lead time of the first pulse of the multi pulse train relative to the trailing edge of the second channel bit of the data pulse for recording at maximum velocity. The value is expressed in fractions of the channel bit clock period as a number n such that

n=16×dTₜₒₚ/T_{W} and 0≦n≦24

Byte 53—dTle first pulse leading edge correction for previous space=3 at maximum velocity.
Bit 7 to bit 4 of this byte shall specify the leading edge correction for the 1st pulse of the multi pulse train when the previous space was a 3T space for recording at maximum velocity. The value is expressed in fractions of the channel bit clock period according to FIG. 8.

### Bytes 54 to 63—Reserved—All (00).

These bytes shall be set to all (00).
   Bytes (64+i×32) to (95+i×32)—Extended Information block i (i=0 . . . 5)
To facilitate future extensions, Extended Information blocks are introduced. Each such block consists of 32 bytes. These bytes can hold for instance parameters for an alternative write strategy, e.g. for High-Speed recording, or other advanced parameters. The presence of an Extended Information block shall be indicated by a bit in byte 18.
Byte (64+i×32) Extended Information block i version number indicates the block version and identifies the definitions of the data in bytes (64+i×32) to (95+i×32). A disc can have several Extended Information blocks of which the block version numbers can be the same as well as different.
   Drives not acquainted with the specific block version number in block i, should not use the disc with the advanced parameters in this Extended Information block.
   If the block version number is set to 255, the related Extended information block is not an independent block but a continuation of the preceding Extended Information block (to be used if 32 bytes are not sufficient for a set of parameters).
      Bytes (65+i×32) to (95+i×32)
   these bytes can be used to hold alternative write strategies or other parameters.

### Example for High-Speed Write Strategy Parameters

Byte 18: 0000 0001 indicating Extended Information block 0 is in use.
Byte 64: 0000 0001 indicating block version 1, for which bytes 65 to 95 have the following meaning:
Byte 65: Maximum recording velocity for the parameter set in this EI block: n×0.25 m/s, (max≦63.75 m/s=18.25x=175 Hz@R=58 mm)
   Byte 66: Minimum recording velocity for the parameter set in this EI block: n×0.25 m/s, (minimum recording velocity is allowed to be=maximum recording velocity)
Byte 67: reserved and set to (00)
Byte 68 to 81: parameter set for maximum recording velocity
byte 68: PIND
byte 69: βtarget
byte 70: Ttop (≧4) first pulse duration for cm ≧4
byte 71: Ttop (=3) first pulse duration for cm =3
byte 72: Tmp multi pulse duration
byte 73: Tlp last pulse duration
byte 74: dTtop (≧4) first pulse lead time for cm ≧24
byte 75: dTtop (=3) first pulse lead time for cm =3
byte 76: dTle 1st pulse leading edge correction for ps =3
byte 77: dTle 1st pulse leading edge correction for ps =4
byte 78: reserved and set to (00)
byte 79: reserved and set to (00)
byte 80: reserved and set to (00)
byte 81: reserved and set to (00)
Byte 82 to 95: parameter set for minimum recording velocity
byte 82: PIND
byte 83: βtarget
byte 84: Ttop (≧4) first pulse duration for cm ≧4
byte 85: Ttop (=3) first pulse duration for cm =3
byte 86: Tmp multi pulse duration
byte 87: Tlp last pulse duration
byte 88: dTtop (≧4) first pulse lead time for cm ≧4 byte 89: dTtop (=3) first pulse lead time for cm =3
byte 90: dTle 1st pulse leading edge correction for ps =3
byte 91: dTle 1st pulse leading edge correction for Ps =4
byte 92: reserved and set to (00)
byte 93: reserved and set to (00)
byte 94: reserved and set to (00)
byte 95: reserved and set to (00)

The Extended information blocks can be used to store the numerical gain setting of the waveform equalizer 6, byte 64 for example.

For an information carrier 11 with the Blu-ray Disc Recordable (BD-R) format the numerical gain setting can for instance be stored in the Permanent Information & Control data zone (PIC) of the information carrier 11. The PIC zone is located in the Lead-in Zone. The PIC zone contains a Disc Information table which is perfectly suitable for storing the numerical gain setting.

An example of the internal structure of the waveform equalizer 6 is shown in FIG. 5. The waveform equalizer shown in FIG. 5 has three tap delays D1 to D3 and four amplifying units A1 to A4. The value of K in the amplifying units is read out from the information carrier 11 en the setting means 1 set the value of K to a value dependent of the read numerical gain setting. The outputs of the amplifying units A1 to A4 are summed by an adder B1, resulting in the corrected signal S′.

The waveform equalizer 6 may be followed by a limit equalizer. This embodiment is shown in FIG. 6.

The read signal S is fed to the same waveform equalizer 6 as shown in FIG. 5. The output of the waveform equalizer 6 is fed to amplitude limiting means 62. The amplitude limiting means 62 performs amplitude limitation on the output of waveform equalizer 6, and supplies an obtained amplitude limited signal SLIM to the second filter 63. The read signal S is also an input of the first filter 61. The output of filter 61 and of filter 63 are added by adder 64.

The amplitude limiting circuit 62 counteracts an increase of inter symbol interference. Without the amplitude limiting circuit 62, if an excessive high frequency emphasis is made, inter symbol interference increases and, as a result jitter increases.

In FIG. 6 the first filter 61 is a FIR filter with tap coefficients [0,0,0,1]. This means that the input to this filter is delayed by three tap delays D7, D8 and D9. The tap delays delay the input a time T approximately equal to period of the channel bit clock with which the bits were written on the information carrier. The output O_{fl} of the first filter 61 relates to the input, the read signal S, of this filter as expressed in equation 1:

O_{fl}(n)=S(n−3) Equation 1

where O_{fl}(n) stands for the output of the first filter 61 at sampling instant n, and S(n−3) stands for the input of the first filter 61 at sampling instant n−3.

The second filter 63 is a FIR filter having tap coefficients [−m,+m,+m,−m]. This means that an input to this filter is delayed by three tap delays D4, D5 and D6, and there are four outputs fed to amplifying units A5, A6, A7 and A8 having an amplification factor of respectively −m, +m, +m and −m. The first amplifier A5 placed directly after the input SLIM, the second amplifier A6 is placed after the first delay tap D4, etc. The outputs of the amplifying units A5 to A8 are added by adder B2. The output O_{f2} of the second filter relates to the input Sₗᵢₘ of the second filter 63 as expressed in equation 2:

O_{f2}(n)=−m.Sₗᵢₘ(n)+m.Sₗᵢₘ(n−1)+m.Sₗᵢₘ(n−2)+−m.Sₗᵢₘ(n−3) Equation 2

The total output S′ of this embodiment of the waveform equalizer 6:

S′=−m.Sₗᵢₘ(n)+m.Sₗᵢₘ(n−1)+m.Sₗᵢₘ(n−2)+−m.Sₗᵢₘ(n−3)+S(n−3) Equation 3

The optimal value of the gains K and/or m is dependent on the noise characteristics of the information carrier 11. The optimal value of the gains K and/or m is therefore stored on the information carrier 11, read out by the gain setting means 1 and subsequently set to the read numerical gain setting.

After this description of the invention with reference to preferred embodiments thereof, it is to be understood that these are not limitative examples. Thus, various modifications will be apparent to those skilled in the art, without departing from the scope of the invention, as defined in the claims.

1. An apparatus for reproducing information recorded on an information carrier (11) comprising:
a waveform equalizer (6) for obtaining a corrected signal S′ by performing a waveform equalization to a read signal S read out from the information carrier (11), the waveform equalizer (6) having an amplifying element with a gain K;
gain setting means (1) for reading a numerical gain setting stored on the information carrier (11) and setting the gain K of the amplifying element to a value related to the numerical gain setting.

2. An apparatus as claimed in claim 1, wherein the waveform equalizer (6) comprises a FIR filter able to perform a filtering process to said read signal S, the FIR filter having tap coefficients
$$[ \frac{- K}{2} , \frac{1 + K}{2} , \frac{1 + K}{2} , \frac{- K}{2} ] .$$

3. An apparatus as claimed in claim 1, wherein the waveform equalizer (6) is followed by a limit equalizer.

4. An apparatus as claimed in claim 3, wherein the limit equalizer comprises
a first FIR filter (61) able to perform a filtering process to said read signal S, having tap coefficients [0,0,0,1];
amplitude limiting means (62) able to obtain an amplitude limited read signal S_{LIM} by limiting an amplitude level of said read signal S by a predetermined amplitude limitation value;
a second FIR filter (63) able to perform a filtering process to said amplitude limited read signal, having tap coefficients [−m,+m,+m,−m], m being a suitable amplification factor;
an adder (64) able to add the signals obtained by performing the filtering process by each of said first and second filters, and output the corrected signal S′.

5. An apparatus as claim in claim 3, wherein the gain setting means 1 are adapted to read an additional numerical gain setting and to set an amplification factor of the limit equalizer to a value related to the additional numerical gain setting.

6. An information carrier (11) for use in an apparatus as claimed in claim 1, the information carrier (11) having stored the numerical gain setting.

7. An information carrier (11) as claimed in claim 6, wherein the information carrier (11) is an optical disc.

8. An information carrier (11) as claimed in claim 6, wherein the numerical gain setting is stored in a Control Data Zone present in a lead-in zone (22) of the information carrier (11).

9. Method for reproducing information recorded on an information carrier (11) comprising the steps of:
obtaining a corrected signal S′ by performing a waveform equalization to a read signal S read out from the information carrier (11) using a waveform equalizer (6) having an amplifying element with a gain K;
reading a numerical gain setting stored on the information carrier (11) and setting the gain K of the amplifying element to a value related to the numerical gain setting.

10. Method as claimed in claim 9, wherein the waveform equalizer (6) is followed by a limit equalizer.
